(19) United States
(12) Patent Application Publication
(10) Pub. No.: US 2021/0211868 A1
(43) Pub. Date: Jul. 8, 2021

(54) MOBILE DEVICE APPLICATION SOFTWARE SECURITY

(71) Applicant: International Business Machines Corporation, Armonk, NY (US)

(72) Inventors: Cesar Augusto Rodriguez Bravo, Alajuela (CR); Kevin Jimenez Mendez, HEREDIA (CR); Faraz Ahmad, Noida (IN); Dino Quintero, Merrimack, NH (US)

(21) Appl. No.: 16/735,817

(22) Filed: Jan. 7, 2020

(51) Int. Cl. H04W 12/00; G06F 21/52; G06F 21/74

(52) U.S. Cl. CPC H04W 12/0023; G06F 21/52; G06F 2221/2113; H04W 12/0027; G06F 2221/033; G06F 21/74

(57) ABSTRACT

A security system for a computing device is provided. A computing device receives one or more policy decisions from a primary user. A computing device monitors activity associated with one or more applications by a secondary user on a computing device. A computing device detects unauthorized activity by the secondary user on the computing device. In response to a computing device detecting unauthorized activity by the secondary user on the computing device, a computing device activates protected mode on the computing device.

### BACKGROUND OF THE INVENTION

The present invention relates generally to the field of mobile devices, and more particularly to management and security for application software.

The proliferation of mobile devices has allowed users to dictate various tasks and services. In addition, this enhancement has provided users with a variety of application software to optimize their mobile devices.

### SUMMARY

Embodiments of the present invention provide a method, system, and program product of a security system executing on a computing device.

A first embodiment encompasses a method for a security system executing on an intelligent assistant. One or more processors receive one or more policy decisions from a primary user. The one or more processors monitor activity associated with one or more applications by a secondary user on a computing device. The one or more processors detect unauthorized activity by the secondary user on the computing device. Responsive to detecting unauthorized activity by the secondary user on the computing device, the one or more processors activate protected mode on the computing device.

A second embodiment encompasses a computer program product for a security system executing on an intelligent assistant. The computer program product includes one or more computer-readable storage media and program instructions stored on the one or more computer-readable storage media. The program instructions include program instructions to receive one or more policy decisions from a primary user. The program instructions include program instructions to monitor activity associated with one or more applications by a secondary user on a computing device. The program instructions include program instructions to detect unauthorized activity by the secondary user on the computing device. Responsive to detecting unauthorized activity by the secondary user on the computing device, the program instructions include program instructions to activate protected mode on the computing device.

A third embodiment encompasses a computer system for a security system executing on an intelligent assistant. The computer system includes one or more computer processors, one or more computer readable storage medium, and program instructions stored on the computer readable storage medium for execution by at least one of the one or more processors. The computer program product includes one or more computer-readable storage media and program instructions stored on the one or more computer-readable storage media. The program instructions include program instructions to receive one or more policy decisions from a primary user. The program instructions include program instructions to monitor activity associated with one or more applications by a secondary user on a computing device. The program instructions include program instructions to detect unauthorized activity by the secondary user on the computing device. Responsive to detecting unauthorized activity by the secondary user on the computing device, the program instructions include program instructions to activate protected mode on the computing device.

### BRIEF DESCRIPTION OF THE SEVERAL VIEWS OF THE DRAWINGS

FIG. 1 is a functional block diagram illustrating a computing environment, in which a security system executes on a computing device, in accordance with an exemplary embodiment of the present invention.

FIG. 2 illustrates operational processes of a security system executing on a computing device within the environment of FIG. 1, in accordance with an exemplary embodiment of the present invention.

FIG. 3 illustrates operational processes of a security system authorizing a secondary user on a computing device within the environment of FIG. 1, in accordance with an exemplary embodiment of the present invention.

FIG. 4 depicts a cloud computing environment according to at least one embodiment of the present invention.

FIG. 5 depicts abstraction model layers according to at least one embodiment of the present invention.

FIG. 6 depicts a block diagram of components of one or more computing devices within the computing environment depicted in FIG. 1, in accordance with an exemplary embodiment of the present invention.

### DETAILED DESCRIPTION

Detailed embodiments of the present invention are disclosed herein with reference to the accompanying drawings. It is to be understood that the disclosed embodiments are merely illustrative of potential embodiments of the present invention and may take various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

While possible solutions to mobile device security are known, these solutions may be inadequate to proactively engage the user of the mobile device and prevent a secondary user from accessing various applications that the owner of the device wishes the secondary user to not interact with. While it is important that a mobile device provide and allow users to interact with the downloaded software, it is also advantageous that the primary user be able to dictate and authorize secondary users to utilize certain applications and simultaneously prevent secondary users from using various other applications.

In general, users of mobile devices download various software applications and store these applications directly on the mobile device, while other software applications were downloaded by the manufacturer and reside on the mobile device for use and functionality. Mobile device security often leverages software applications to prevent the mobile device and the primary user from external hackers and data miners. Generally, these mobile device security software applications provide a firewall, antivirus, encryption, authentication, etc. to prevent security threats from comprising the integrity of the mobile device.

Embodiments of the present invention recognize that certain mobile devices may not provide an adequate security system for unwanted users. Embodiments provide mobile device security systems that increase security by allowing the primary user to prevent and/or limit unwanted users from accessing data stored on the mobile device. Such security systems include, but are not limited to, biometric authentication, authorization for use of a single application, authorization for use of one or more applications, trigger mobile device lock when a secondary user attempts to navigate towards a restricted application. Embodiments further recognize that a lack of security could allow unwanted users (e.g., secondary users) to access data and application software stored on the mobile device.

In some embodiments, an enhanced level of security offers additional safety measures for mobile devices to analyze and determine whether a user is authorized by leveraging policy decisions and triggers in that determination. As opposed to allowing any and/or all users access to the data and application software stored on the mobile device, the use of a security system creates an improved safety feature for mobile devices. When a mobile device leverages policy decisions established by the privileged user and/or triggers to determine whether to enable a protected mode for the mobile device, then the mobile device can authenticate secondary users and/or prevent secondary users from accessing various data and application software stored on the mobile device. Such an approach often yields in an increase in the level of safety in mobile devices and can add a level of autonomy to the privileged users of the mobile device.

In one embodiment of the present invention, authentication program 132 receives one or more policy decisions from a primary user. Authentication program 132 monitors activity associated with one or more applications by a secondary user on a computing device. Authentication program 132 detects unauthorized activity by the secondary user on computing device 120. In response to detecting authorized activity by the secondary user on computing device 120, authentication program 132 activates protected mode on the computing device.

In one embodiment, authentication program 132 receives the one or more policy decisions from the primary user. Authentication program 132 analyzes the one or more policy decisions from the primary user. Authentication program 132 stores (i) the one or more policy decisions and (ii) the one or more identified data requests on a database.

In one embodiment of the present invention, authentication program 132 receives one or more data request from the primary user. Authentication program 132 analyzes the one or more data requests from the primary user. Authentication program 132 determines that the one or more data requests match the one or more policy decisions stored on database 134.

In one embodiment of the present invention, response to determining that the one or more data requests match the one or more policy decisions stored on database 134, authentication program 132 identifies a threshold level of security based on (i) the one or more data requests and (ii) the one or more policy decisions. Authentication program 132 determines to activate protected mode on a computing device. Authentication program 132 generates one or more policy responses associated with the one or more data requests that match the one or more policy decisions stored on the database, and includes, but is not limited to, a command to activate protected mode associated with threshold level of security.

In one embodiment of the present invention, authentication program 132 communicates the one or more policy responses. Authentication program 132 activates protected mode on the computing device associated with a threshold level of security. Authentication program 132 monitors user activity on computing device 120. Authentication program 132 identifies unauthorized user activity on computing device 120. Authentication program 132 executes a lock screen function on the computing device in response to identifying the unauthorized user activity.

In one embodiment of the present invention, authentication program 132 populates computing device 120 with a login prompt. Authentication program 132 receives one or more login attempts. Authentication program 132 analyzes the one or more login attempts. Authentication program 132 authorizes a user associated with a correct login attempt. Authentication program 132 deactivates the protected mode in response to authorizing a user associated with a correct login attempt.

In one embodiment of the present invention, authentication program 132 generates a protection report that includes, but is not limited to, (i) the one or more login attempts to authorize a user and (ii) a time and date in which a user was authorized.

The present invention will now be described in detail with reference to the Figures.

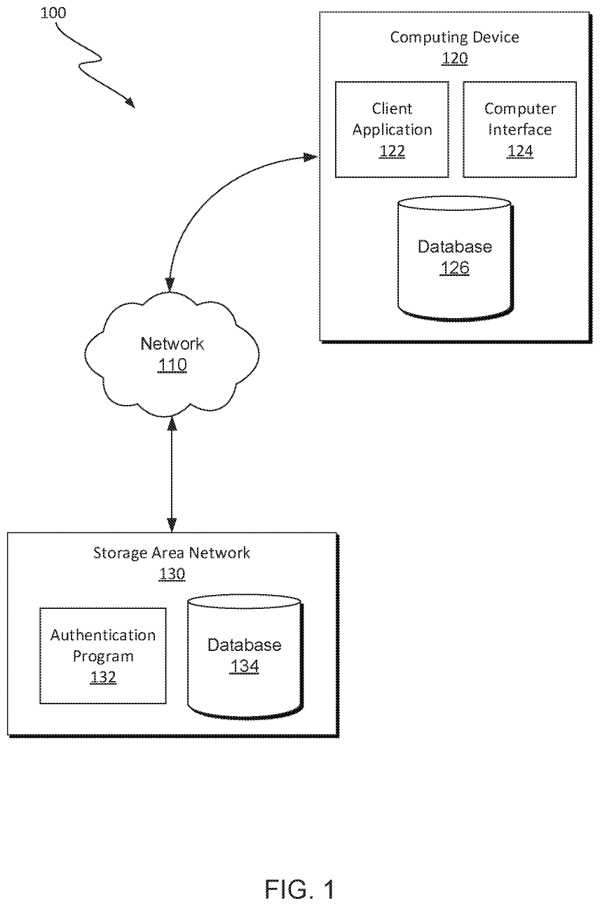

FIG. 1 is a functional block diagram illustrating a computing environment, generally designated 100, in accordance with one embodiment of the present invention. Computing environment 100 includes computing device 120 and storage area network (SAN) 130 connected over network 110. Computing device 120 includes client application 122, computer interface 124, and database 126. SAN 130 includes authentication program 132.

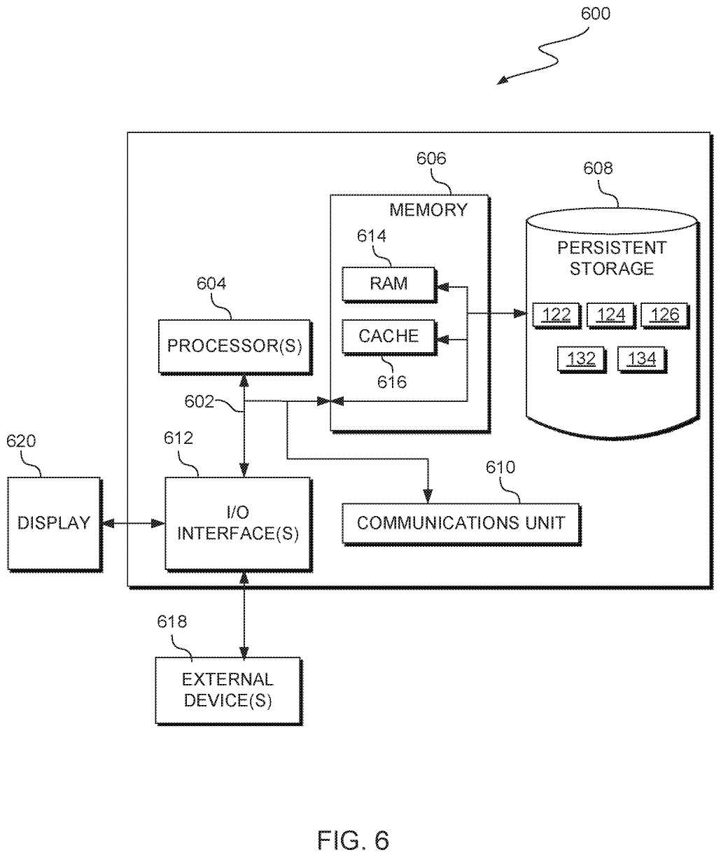

In various embodiments of the present invention, computing device 120 is a computing device that can be a standalone device, a server, a laptop computer, a tablet computer, a netbook computer, a personal computer (PC), a personal digital assistant (PDA), smartwatch, smartphone, smart speaker, a desktop computer, or any programmable electronic device capable of receiving, sending and processing data. In general, computing device 120 represents any programmable electronic device or combination of electronic programmable electronic devices capable of executing machine readable program instructions and communication with SAN 130. In another embodiment, computing device 120 represents a computing system utilizing clustered computers and components to act as a single pool of seamless resources. In general, computing device 120 can be any computing device or a combination of devices with access to SAN 130 and network 110 and is capable of executing client application 122 and computer interface 124. Computing device 120 may include internal and external hardware components, as depicted and described in further detail with respect to FIG. 6. Computing device 120 includes software and hardware components that represent, but are not limited to, speakers, microphones, audio signal processors, cameras, and/or other integrated and peripheral devices that are connected to a given computing device.

In this exemplary embodiment, client application 122 is stored on computing device 120. However, in other embodiments, client application 122 may be stored externally and accessed through a communications network, such as network 110. Network 110, can be, for example, a local area network (LAN), a wide area network (WAN) such as the Internet, or a combination of the two, and may include any combination of connections and protocols that will support communications between computing device 120 and SAN 130, in accordance with a desired embodiment of the present invention.

Computing device 120 includes an interface that provides an interface between computing device 120 and SAN 130, over network 110. In some embodiments, the interface can be a graphical user interface (GUI), a web user interface (WUI), or a voice user interface (VUI) and can present text, documents, web browser, windows, user options, application interfaces, text to speech, sounds, tones, and instructions for operation, and includes the information (such as graphic, text, and sound) that a program presents to a user and the control sequences the user employs to control the program. In some embodiments, computing device 120 accesses data communicated from client application 122 and/or SAN 130 via client-based application that runs on computing device 120. For example, computing device 120 includes an operating system and application software that provides an interface between computing device 120, SAN 130, various networks (not shown), and various other computing systems (not shown) that are connected via network 110.

In various embodiments of the present invention, client application 122 operates on computing device 120. In another embodiment, client application 122 operates on SAN 130 or another computing device (not shown). Client application 122 represents one or more of, or a combination of, but is not limited to, operating system, various application software, sensors, microphones, speakers, computing programs, or any combination thereof, that collects data from a user of computing device 120 (herein after “requestor”). In various embodiments, client application 122 receives a series of words, phrases, biometric data, and/or interaction on computing device or other computing devices (not shown) to communicate data to the requestor based, at least in part, on the data client application 122 received from the requestor.

Storage area network (SAN) 130 is a storage system that includes authentication program 132 and database 134. SAN 130 may include one or more, but is not limited to, computing devices, server-cluster, database and storage devices. SAN 130 operates to communicate with computing device 120 and other various computing devices (not shown) over a network, such as network 110. For example, SAN 130 communicates with client application 122 to transfer data between, but is not limited to, database 134 and various other databases (not shown) that are connected to network 110. In general, SAN 130 can be any computing device or a combination of devices that are communicatively connected to a local IoT network, i.e., a network comprised of various computing devices including, but is not limited to computing device 120 to provide the functionality described herein. SAN 130 can include internal and external hardware components as described with respect to FIG. 6. The present invention recognizes that FIG. 1 may include any number of computing devices, servers, databases, and/or storage devices, and the present invention is not limited to only what is depicted in FIG. 1. As such, in some embodiments, some of the features and functions of computing device 120 are included as part of SAN 130 and/or another computing device.

Additionally, in some embodiments, SAN 130 represents a cloud computing platform. Cloud computing is a model or service for enabling convenient, on demand network access to a shared pool of configurable computing resources (e.g., networks, network bandwidth, servers, processing, memory, storage, applications, virtual machines, and services) that can be rapidly provisioned and released with minimal management effort or interaction with a provider of a service. A cloud model may include characteristics such as on-demand self-service, broad network access, resource pooling, rapid elasticity, and measured service, can be represented by service models including platform as a service (PaaS) model, an infrastructure as a service (IaaS) model, and a software as a service (SaaS) model; and can be implemented as various deployment models including a private cloud, a community cloud, a public cloud, and a hybrid cloud.

In various embodiments, SAN 130 represents a local IoT network. In the embodiment depicted in FIG. 1, authentication program 132 is respectively stored on and executed by SAN 130. In other embodiments, client application 122 can store and/or execute a different count of applications without departing from the scope of the present invention. In general, authentication program 132 operates to transmit respective data to SAN 130, as described herein. Additionally, authentication program 132 operates to notify, via network 110, computing device 120 and other various computing devices (not shown) of conditions and/or respective contract events that may occur within SAN 130. In one example, authentication program 132 takes the form of a well-being monitoring application that utilizes elements of SAN 130 to monitor data transmitted from computing device 120 and various other computing devices (not shown) regarding the status of protected mode on computing device 120, but are not limited hereto. These examples will be referenced in various embodiments herein to illustrate various aspects of the present invention, but the present invention is not to be construed as being limited to such embodiments. In some embodiments, IoT applications executing on SAN 130 can also include analytical logic to analyze data from one or more gateways to facilitate optimization of device configuration of device configuration rules, template, rules, and other logical operations utilized by the gateway(s), as described herein.

In various embodiments, SAN 130 is depicted in FIG. 1 for illustrative simplicity. However, it is to be understood that, in various embodiments, SAN 130 includes any number of databases that are managed in accordance with the functionality of authentication program 132. In general, database 134 represents data and authentication program 132 manages the ability to view the data. In other embodiments, authentication program 132 represents code that provides the ability to take specific action with respect to another physical or virtual resource and authentication program 132 manages the ability to use and modify the data. Client application 122 can also represent any combination of the aforementioned features, in which authentication program 132 has access to database 134. To illustrate various aspects of the present invention, examples of client application 122 are presented in which client application 122 represents one or more of, but is not limited to, a local IoT network and security system program.

In this exemplary embodiment, authentication program 132 and database 134 are stored on SAN 130. However, in another embodiment, authentication program 132 and database 134 may be stored externally and accessed through a communications network, such as network 110. Network 110 can be, for example, a local are network (LAN), a wide area network (WAN) such as the Internet, or a combination of the two, and may include wired, wireless, fiber optic, or any other connection known in the art. In general, network 110 can be any combination of connections and protocols that will support communications between computing device 120, SAN 130, and various other computing devices (not shown) in accordance with a desired embodiment of the present invention.

In the embodiment depicted in FIG. 1, authentication program 132, at least in part, has access to client application 122 and can communicate data stored on SAN 130 to computing device 120. Alternatively, client application 122 has access to authentication program 132 and can communicate data stored on computing device 120 and SAN 130. In some embodiments, computing device 120 and SAN 130 have access to various other computing devices (not shown) and can communicate data stored, respectively on computing device 120 and SAN 130 to the various other computing devices. For example, client application 122 defines a smartphone that has access to database 134 and has access to data on other computing devices (not shown).

In various embodiments depicted in FIG. 1, data is, at least in part, obtained from client application 122. Client application 122 can include, but is not limited to, digital cameras, biometric devices, speakers, microphones, sound processors, touch-based screens. Client application 122 operates to monitor and transmit data from requestors to authentication program 132.

In some embodiments depicted in FIG. 1, computing device 120 represents, but is not limited to, a smart speaker, smart device, smart watch, and includes, but is not limited to, client application 122. Additionally, client application 122 operates to collect data from users of computing device 120, as described above, and authentication program 132 operates to analyze the data obtained from client application 122 to determine the applicable response to be communicated to the user of computing device 120. In general, authentication program 132 operates to control access to data stored on database 134 and/or approve or deny actions made by the user of computing device 120. Additionally, authentication program 132 operates to analyze the data obtained from client application 122 in conjunction with data obtained from SAN 130 (i.e., data communicated from various other computing devices) and operate to communicate a response based, at least in part, on the request made by the requestor of computing device 120.

In various embodiments of the present invention, authentication program 132 is capable of receiving any form of input (e.g., data) from client application 122, wherein a user of computing device 120 communicated data to computing device 120. Authentication program 132 is capable of receiving data in the form of including, but is not limited to, text, speech, video, images, biometrics, etc. In some embodiments, authentication program 132 receives this data in any form of input from a privileged user. Additionally, in some embodiments, authentication program 132 receives this data in any form of input including, but is not limited to, (i) one or more secondary requestors and/or (ii) one or more unidentifiable requestors. One having ordinary skill in the art would understand that for authentication program 132 to receive and identify data in various formats, authentication program 132 utilizes technology that includes, but is not limited to, voice recognition, voice pattern matching technology, image recognition technology, biometrics, etc.

In various embodiments depicted in FIG. 1, computing device 120 represents, but is not limited to, a smart device, smartphone, smart watch, tablet computer, personal computer (PC), etc. A primary user represents the owner of computing device 120 and is authorized to use and operate the device. In various embodiments, the primary user utilizes client application 122 to execute various application software stored on database 126. In some embodiments, the primary user may execute one or more application software at any give time. Additionally, one or more application software may be running in the background of computing device 120 at any given time.

In various embodiments, the primary user of computing device 120 utilizes client application 122 to execute an application software. In various embodiments, one or more application software is running in the background of computing device 120 and one application software is populated on the screen of computing device 120. In some embodiments, the primary user authorizes, at least, one secondary user to utilize computing device 120 (e.g., the primary user offers a secondary user to hold and observe the screen of a smartphone). In some embodiments, the primary user wishes for the secondary user to view only the application software populated on computing device 120, (i) without navigating towards one or more application software running in the background and/or (ii) executing one or more application software stored on database 126. In some embodiments, the primary user communicates to client application 122 a data request to prevent the secondary user from navigating away from the application software populated on computing device 120 or allow the secondary user limited to access to various other application software stored on computing device 120 (e.g., stored on database 126 operating on computing device 120).

In various embodiments of the present invention, a primary user utilizing client application 122 creates one or more policy decisions that are utilized by authentication program 132 to authenticate a data request. In some embodiments, a primary user creates one or more policy decisions, when authorized by authentication program 132, activate protected mode on computing device 120. In various embodiments, authentication program 132 receives one or more policy decisions from client application 122. In some embodiments, authentication program 132 analyzes the one or more policy decisions and identifies the various data requests authentication program 132 can receive. Authentication program 132 stores the one or more policy decisions on database 134 for subsequent use by authentication program 132. In various embodiments, the one or more policy decisions include, but are not limited to, (i) touch-based key combinations, verbal commands, secondary computing device commands, and proximity-based commands.

In various embodiments of the present invention, the primary user of computing device 120 communicates a data request to client application 122 executing on computing device 120. In various embodiments, the data request includes, but is not limited to, a request to lock the current application software populated on the screen of computing device 120. Additionally, the data request includes, but is not limited to, activating protected mode on computing device 120. In various embodiments, if client application 122 determines that the secondary user attempts to navigate away from the locked application software populated on computing device 120, client application 122 activates the lock screen function and populates the password and/or passcode screen on computing device 120. The present invention recognizes that to utilize the functionality of the device, a user must successfully enter the password and/or passcode to unlock the device. In various embodiments, client application 122 analyzes the data request and identifies that the primary user wishes to enable protected mode on computing device 120. Client application 122 communicates the data request to authentication program 132 executing on SAN 130.

In various embodiments of the present invention, client application 122 receives a verbal data request from a primary user of computing device 120. In various embodiments, client application 122 actively monitors the environment of computing device 120 utilizing sensors that include, but are not limited to, microphones, audio signal processors, camera, etc. The present invention recognizes that client application 122 includes, but is not limited to, software (e.g., speech to text, speech processing, etc.) to analyze the data request communicated by the primary user. In various embodiments, client application 122 analyzes the data request and identifies that the primary user wishes to enable protected mode on computing device 120. Client application 122 communicates the data request to authentication program 132 executing on SAN 130.

In various embodiments, authentication program 132 analyzes the data request received from client application 122. In various embodiments, the data request includes, but is not limited to, (i) the current application software populated on computing device 120, (ii) the breadth of security that protected mode is to be enabled on computing device 120, and (iii) whether or not the secondary user is allowed to access various other application software stored on computing device 120. The present invention recognizes that the breadth of security enabled by protected mode includes, but is not limited to, (i) allowing the secondary user to view the current application software populated on computing device 120, (ii) allowing the secondary user access to specified application software by the primary user, or (iii) whether the secondary user has full access to the data stored on computing device 120.

In various embodiments, the primary user communicates a data request by utilizing an application stored on computing device 120 to transmit the data request to enable protected mode on computing device 120. In various embodiments, authentication program 132 identifies that the primary user is requesting protected mode to be enabled on computing device 120. Additionally, authentication program 132 further identifies the breadth of security that the primary user wishes to enable utilizing protected mode. In some embodiments, as described above, the primary user may wish to enable a threshold level of protected mode, wherein the secondary user only has access to the current populated application software on computing device 120. In various embodiments, authentication program 132 generates a policy decision, associated with the data request, that includes, but is not limited to, (i) enabling protected mode on computing device 120 so that the secondary user only has access to current populated application software and (ii) populating computing device 120 with the lock screen function which requires the successful input of the password and/or passcode to unlock computing device 120. In some embodiments, authentication program 132 communicates the policy decision to client application 122 to enable protected mode on computing device 120.

In an alternative embodiment, client application 122 receives the policy decision from authentication program 132 and activates protected mode on computing device 120. In various embodiments, client application 122 continually displays the current application software for the secondary user to access. In some embodiments, client application 122 monitors the activity on computing device 120 while protected mode is enabled. In some embodiments, client application 122 determines that a user of computing device 120 attempts to navigate away from the current populated application software and, based on the policy decision received from authentication program 132, client application 122 executes the lock screen function on computing device 120.

In various embodiments, (i) a user must successfully input the correct password and/or passcode to unlock computing device 120 and (ii) successful input of the correct password and/or passcode is required to deactivate protected mode. In some embodiments, client application 122 receives the password and/or passcode and communicates the password and/or passcode to authentication program 132 for authentication. In some embodiments, authentication program 132 analyzes the password and/or passcode and determines whether the password and/or passcode matches the correct password and/or passcode stored on database 134. In one embodiment, authentication program 132 determines that the correct password and/or passcode was input and communicates a validation message to client application 122. In various embodiments, client application 122 receives the validation message and unlocks computing device 120 and deactivates protected mode. In some embodiments, authentication program 132 determines that the incorrect password and/or passcode was input and communicates a message instructing client application 122 to request the user to input, at least, a second password and/or passcode. In some embodiments, client application 122 continues to communicate the input password and/or passcode to authentication program 132 until authentication program 132 can authenticate the input password and/or passcode.

In various embodiments, client application 122 generates a protection report that includes, but is not limited to, (i) the number of attempts to unlock computing device 120 and (ii) the time and date in which computing device 120 was successfully unlocked. In some embodiment, client application 122 stores the protection report on database 126. In an alternative embodiment, client application 122 communicates the protection report to authentication program 132.

In various embodiments of the present invention, a primary user wishes to enable protected mode on computing device 120 utilizing, at least, a second computing device (e.g., smartwatch, personal computer, etc.). In various embodiments, the primary user utilizing, at least, a second computing device generates a data request and communicates the data request to authentication program 132. In some embodiments, authentication program 132 receives the data request and analyzes the data request to identify the breadth of security enabled by protected mode requested by the primary user.

In various embodiments of the present invention, the primary user utilizes Bluetooth low energy, NFC tag, RFID, etc., executing on a second computing device. In some embodiments, the primary user communicates a data request to client application 122 that includes, but is not limited to, proximity location, geotagging, etc., to determine whether the primary user has reached a threshold level distance (e.g., proximity) from computing device 120. In various embodiments, if the primary user utilizing a second computing device reaches a threshold level distance from computing device 120, client application 122 activates protected mode and locks computing device 120. In some embodiments, client application 122 populates computing device 120 with the password and/or passcode screen and a user must successfully input the correct password and/or passcode to unlock computing device 120 and deactivate protected mode.

In various embodiments, a primary user establishes a policy decision associated with the second computing device, wherein if the primary user reaches a threshold level distance from computing device 120 then client application 122 activates protected mode and populates computing device 120 with the password and/or passcode screen. In various embodiments, the primary user communicates this policy decision to client application 122, wherein client application 122 analyzes the policy decision and identifies the policy decision and communicates the policy decision to authentication program 132. In various embodiments, authentication program 132 analyzes the policy decision and determines the threshold level distance the primary user utilizing the second computer device must reach to activate protected mode. In some embodiments, authentication program 132 stores this policy decision on database 134. Additionally, in various embodiments, authentication program 132 generates a proximity policy response and communicates the proximity policy response to client application 122 with program instructions, instructing client application 122 to activate protected mode if the primary user utilizing the second computing device reaches a threshold level distance from computing device 120.

In various embodiments, authentication program 132 analyzes the data request received from client application 122. In various embodiments, the data request includes, but is not limited to, (i) the current application software populated on computing device 120, (ii) the breadth of security that protected mode is to be enabled on computing device 120, and (iii) whether or not the secondary user is allowed to access various other application software stored on computing device 120. The present invention recognizes that the breadth of security enabled by protected mode includes, but is not limited to, (i) allowing the secondary user to view the current application software populated on computing device 120, (ii) allowing the secondary user access to specified application software by the primary user, or (iii) whether the secondary user has full access to the data stored on computing device 120.

In various embodiments, authentication program 132 identifies that the primary user is requesting protected mode to be enabled on computing device 120. Additionally, authentication program 132 further identifies the breadth of security that the primary user wishes to enable utilizing protected mode. In some embodiments, as described above, the primary user may wish to enable a threshold level of protected mode, wherein the secondary user only has access to the current populated application software on computing device 120. In various embodiments, authentication program 132 generates a policy decision, associated with the data request, that includes, but is not limited to, (i) enabling protected mode on computing device 120 so that the secondary user only has access to current populated application software and (ii) populating computing device 120 with the lock screen function which requires the successful input of the password and/or passcode to unlock computing device 120. In some embodiments, authentication program 132 communicates the policy decision to client application 122 to enable protected mode on computing device 120.

In an alternative embodiment, client application 122 receives the policy decision from authentication program 132 and activates protected mode on computing device 120. In various embodiments, client application 122 continually displays the current application software for the secondary user to access. In some embodiments, client application 122 monitors the activity on computing device 120 while protected mode is enabled. In some embodiments, client application 122 determines that a user of computing device 120 attempts to navigate away from the current populated application software and, based on the policy decision received from authentication program 132, client application 122 executes the lock screen function on computing device 120.

In various embodiments, (i) a user must successfully input the correct password and/or passcode to unlock computing device 120 and (ii) successful input of the correct password and/or passcode is required to deactivate protected mode. In some embodiments, client application 122 receives the password and/or passcode and communicates the password and/or passcode to authentication program 132 for authentication. In some embodiments, authentication program 132 analyzes the password and/or passcode and determines whether the password and/or passcode matches the correct password and/or passcode stored on database 134. In one embodiment, authentication program 132 determines that the correct password and/or passcode was input and communicates a validation message to client application 122. In various embodiments, client application 122 receives the validation message and unlocks computing device 120 and deactivates protected mode. In some embodiments, authentication program 132 determines that the incorrect password and/or passcode was input and communicates a denial message instructing client application 122 to request the user to input, at least, a second password and/or passcode. In some embodiments, client application 122 continues to communicate the input password and/or passcode to authentication program 132 until authentication program 132 can authenticate the input password and/or passcode.

In various embodiments, client application 122 generates a protection report that includes, but is not limited to, (i) the number of attempts to unlock computing device 120 and (ii) the time and date in which computing device 120 was successfully unlocked. In some embodiment, client application 122 stores the protection report on database 126. In an alternative embodiment, client application 122 communicates the protection report to authentication program 132.

In various embodiments of the present invention, client application 122 actively monitors computer interface 124 for touch-based user activity. In some embodiments, client application 122 represents a well-being monitoring system that monitors computer interface 124. In some embodiments, client application 122 identifies a key combination associated with user activity. In some embodiments, the key combination includes, but is not limited to, a pattern of keys-pressed on device (e.g., a keyboard, dial numbers, etc.), a pattern on a touch-based screen, pressing the various functional buttons on the device a plurality of times, etc. In various embodiments, client application 122 generates a key combination request and communicates the key combination request to authentication program 132.

In various embodiments, authentication program 132 analyzes the key combination request and accesses database 134 and retrieves one or more policy decisions from database 134. In some embodiments, authentication program 132 analyzes (i) the key combination request and (i) the one or more policy decisions and determines whether the key combination request matches an established policy decision stored on database 134. In various embodiments, authentication program 132 determines that the key combination request matches one or more policy decision and authentication program 132 generates an approval request and communicates the approval request client application 122. Additionally, in various embodiments, authentication program 132 includes a set of program instructions with the approval request, instructing client application 122 to activate protected mode on computing device 120 associated with (i) the key combination request and (ii) the one or more policy decisions. In an alternative embodiment, client application 122 activates protected mode on computing device 120 and continues to monitor computing device 120 for unauthorized activity.

In an alternative embodiment, client application 122 receives the policy decision from authentication program 132 and activates protected mode on computing device 120. In various embodiments, client application 122 continually displays the current application software for the secondary user to access. In some embodiments, client application 122 monitors the activity on computing device 120 while protected mode is enabled. In some embodiments, client application 122 determines that a user of computing device 120 attempts to navigate away from the current populated application software and, based on the policy decision received from authentication program 132, client application 122 executes the lock screen function on computing device 120.

In various embodiments, (i) a user must successfully input the correct password and/or passcode to unlock computing device 120 and (ii) successful input of the correct password and/or passcode is required to deactivate protected mode. In some embodiments, client application 122 receives the password and/or passcode and communicates the password and/or passcode to authentication program 132 for authentication. In some embodiments, authentication program 132 analyzes the password and/or passcode and determines whether the password and/or passcode matches the correct password and/or passcode stored on database 134. In one embodiment, authentication program 132 determines that the correct password and/or passcode was input and communicates a validation message to client application 122. In various embodiments, client application 122 receives the validation message and unlocks computing device 120 and deactivates protected mode. In some embodiments, authentication program 132 determines that the incorrect password and/or passcode was input and communicates a denial message instructing client application 122 to request the user to input, at least, a second password and/or passcode. In some embodiments, client application 122 continues to communicate the input password and/or passcode to authentication program 132 until authentication program 132 can authenticate the input password and/or passcode.

In various embodiments, client application 122 generates a protection report that includes, but is not limited to, (i) the number of attempts to unlock computing device 120 and (ii) the time and date in which computing device 120 was successfully unlocked. In some embodiment, client application 122 stores the protection report on database 126. In an alternative embodiment, client application 122 communicates the protection report to authentication program 132.

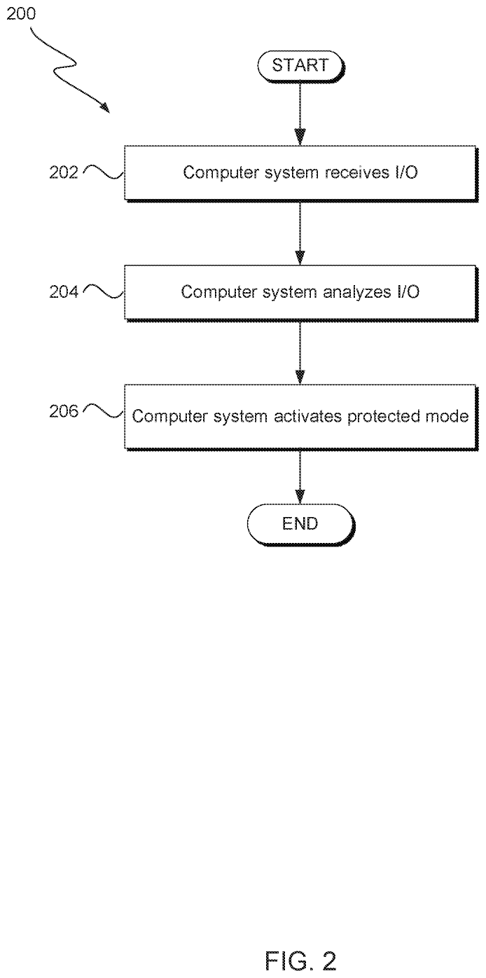

FIG. 2 is a flowchart depicting operations for a security system for computing environment 100, in accordance with an illustrative embodiment of the present invention. More specifically, FIG. 2, depicts combined overall operations 200, of authentication program 132. In some embodiments, operations 200 represents logical operations of authentication program 132, wherein authentication program 132 represents interactions between logical computing devices communicating with SAN 130 and various other computing devices through network 110. It should be appreciated that FIG. 2 provides an illustration of one implementation and does not imply any limitations with regard to the environments in which different embodiments may be implemented. Many modifications to the depicted environment may be made. In one embodiment, the series of operations, in flowchart 200, can be terminated at any operation. In addition to the features previously mentioned, any operations of flowchart 200, can be resumed at any time.

In operation 202, authentication program 132 receives a data request from client application 122, wherein a user (e.g., primary users, secondary user, or unidentifiable user) communicated the data request. As recognized above, authentication program 132 analyzes the data request to identify the context of the request received from a primary user. In some embodiments of the present invention, authentication program 132 identifies the context of the request and accesses the data to retrieve one or more policy decisions based, at least in part, on the primary user who communicated the data request.

In operation 204, authentication program 132 analyzes the data request to identify the threshold level of protected mode the user wishes to enable on computing device 120. In some embodiments, authentication program 132 retrieves one or more established policy decisions from database 134 and further analyzes the data request to determine the threshold level of protected mode. Authentication program 132 identifies that the data request includes, but is not limited to, that the primary user has requested protected mode to be enabled on computing device 120. Additionally, in various embodiments, authentication program 132 identifies the threshold level that the primary user wishes to enable on computing device 120. The present invention recognizes that one or more threshold levels of protected mode exist that can be enabled. In various embodiments, the one or more threshold levels of protected mode include, but are not limited to, (i) activating the lock screen function of computing device 120 if a secondary user attempts to navigate away from the current application software, (ii) allowing the secondary user the ability to navigate away from the current application software but has access to limited to software applications stored on computing device 120, and (iii) allowing the secondary user full access to computing device 120.

In operation 206, authentication program 132 based, at least, on the one or more policy decisions recognized above, activates protected mode on computing device 120. In some embodiments, authentication program 132 generates a policy response and communicates the policy response to client application 122 with program instructions instructing client application 122 to activate protected mode on computing device 120. In various embodiments, client application 122 analyzes the policy response and identifies the threshold level of protected mode and activates protected mode on computing device 120. In some embodiments, client application 122 monitors the activity of computing device 120 and determines whether unauthorized activity is identified. If client application 122 identifies unauthorized activity on computing device 120, client application 122 activates the lock screen function of computing device 120.

In various embodiments, client application 122 populates computing device 120 with the lock screen and communicates the requirement for the user to enter the correct password and/or passcode to provide access to the data stored on computing device 120. As recognized above, client application 122 communicates the password and/or passcode attempt to authentication program 132 for authorization of the password and/or passcode attempt. In the event the correct password and/or passcode is provided, authentication program 132 communicates a validation message to client application 122 with program instructions instructing client application 122 to unlock computing device 120. In the event an incorrect password and/or passcode is provided, authentication program 132 communicates a denial message instructing client application 122 to request the user to input, at least, a second password and/or passcode. In some embodiments, client application 122 continues to communicate the input password and/or passcode to authentication program 132 until authentication program 132 can authenticate the input password and/or passcode.

In various embodiments, a user provides a correct password and/or passcode, client application 122 unlocks computing device 120 and deactivates protected mode on computing device 120. In various embodiments, client application 122 generates a protection report that includes, but is not limited to, (i) the number of attempts to unlock computing device 120 and (ii) the time and date in which computing device 120 was successfully unlocked. In some embodiment, client application 122 stores the protection report on database 126. In an alternative embodiment, client application 122 communicates the protection report to authentication program 132.

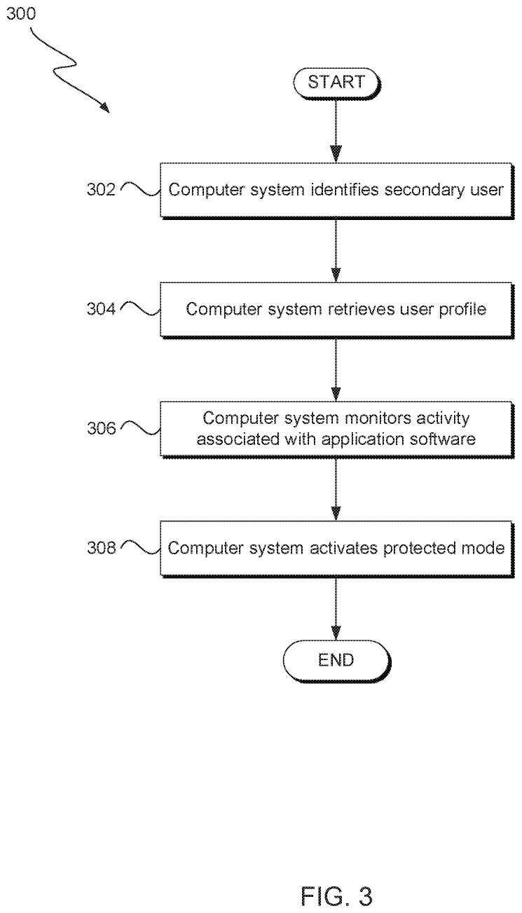

FIG. 3 depicts a flowchart depicting operations for an intelligent assistant to review a verbal request for computing environment 100, in accordance with an illustrative embodiment of the present invention. More specifically, FIG. 3, depicts combined overall operations, 300, of home assistant application 132. In some embodiments, operation 300 represents logical operations of home assistant application 132, wherein client application 122 represents interactions between logical units executing on SAN 130. Further, operations 300 can include a portion or all of combined overall operations of 200. It should be appreciated that FIG. 3 provides an illustration of one implementation and does not imply any limitations with regard to the environments in which different embodiments may be implemented. Many modifications to the depicted environment may be made. In one embodiment of flowchart 300, the series of operations can be performed in any order. In another embodiment, the series of operations, of flowchart 300, can be performed simultaneously. Additionally, the series of operation, in flowchart 300, can be terminated at any operation. In addition to the features previously mentioned, any operations, of flowchart 300, can be resumed at any time.

In operation 302, client application 122 executing on computing device 120 utilizing a sensor (e.g., a camera) analyzes the biometrics of the user of computing device 120. In various embodiments, client application 122 identifies the user as a secondary user. Client application 122 generates a user profile request and communicates the user profile request to authentication program 132.

In operation 304, authentication program 132 accesses database 134 and retrieves one or more user profiles. Authentication program 132 analyzes the one or more user profiles and compares the one or more user profiles with the biometric data communicated within the user profile request. In various embodiments of the present invention, authentication program 132 identifies the user as an authorized user contained within the one or more user profiles. In various embodiments, authentication program 132 generates an approved user profile request and communicates the approved user profile request to client application 122 with program instructions instructing client application 122 to allow the approved user access to computing device 120 with permissions associated with the user profile (e.g., activate protected mode). The present invention recognizes that if authentication program 132 authenticates the user through a user profile, authentication program 132 communicates a policy response to client application 122 with program instructions instructing client application 122 to enable protected mode associated with the permissions contained within the user profile.

In operation 306, client application 122 allows the approved user to navigate various application software associated with the permissions of the user profile. In some embodiments, client application 122 monitors the activity of the approved user. In some embodiments, if client application 122 determines that unauthorized activity by the approved user is identified, in view of the permissions associated with the user profile, client application 122 activates the lock screen function of computing device 120 (operation 308). In various embodiments, if client application 122 populates the lock screen on computing device 120 and prompts the user to enter the password and/or passcode to unlock computing device 120 and deactivate protected mode.

In various embodiments, a user provides a correct password and/or passcode, client application 122 unlocks computing device 120 and deactivates protected mode on computing device 120. In various embodiments, client application 122 generates a protection report that includes, but is not limited to, (i) the number of attempts to unlock computing device 120 and (ii) the time and date in which computing device 120 was successfully unlocked. In some embodiment, client application 122 stores the protection report on database 126. In an alternative embodiment, client application 122 communicates the protection report to authentication program 132.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

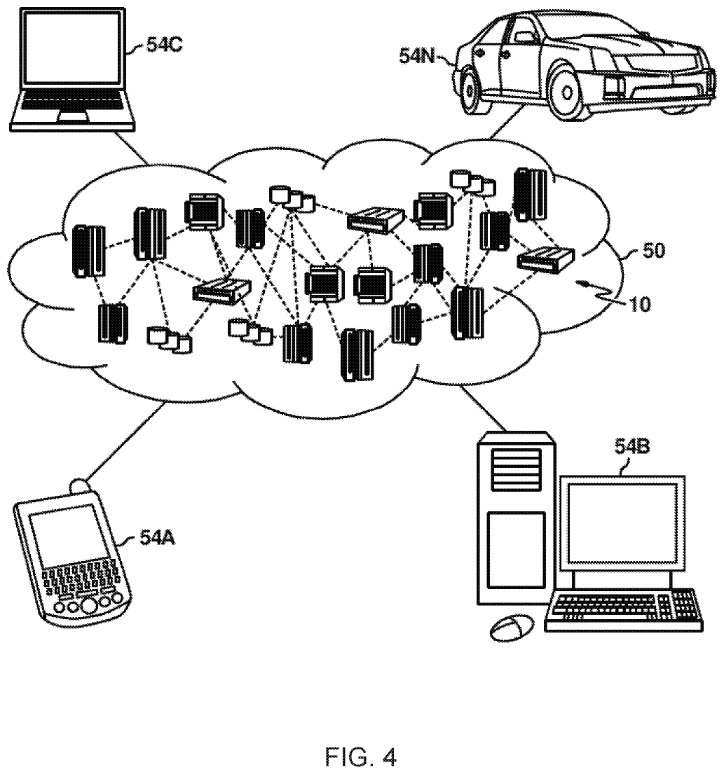

Referring now to FIG. 4, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

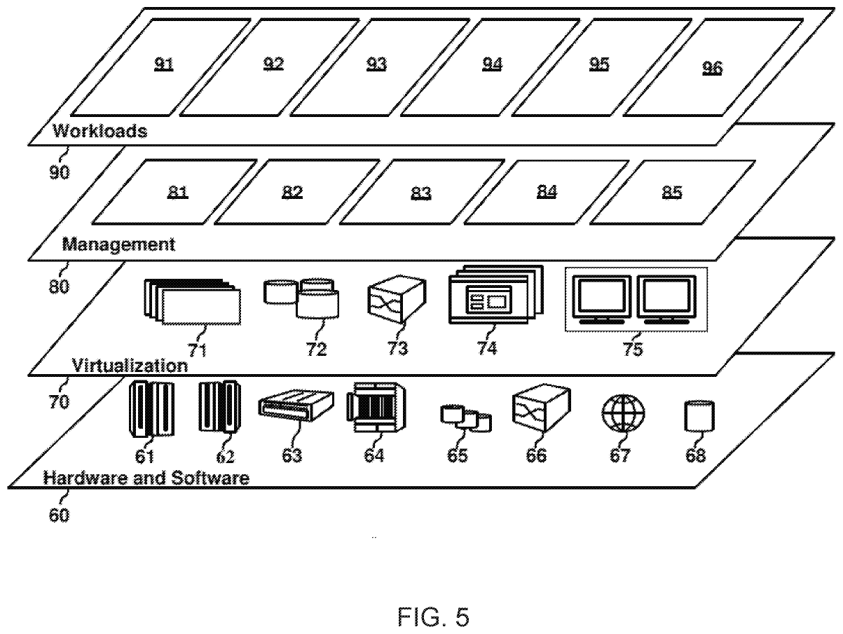

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing soothing output 96.

FIG. 6 depicts a block diagram, 600, of components of computing device 120 and SAN 130, in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Computing device 120 and SAN 130 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer-readable storage media. In this embodiment, memory 606 includes random access memory (RAM) 614 and cache memory 616. In general, memory 606 can include any suitable volatile or non-volatile computer-readable storage media.

Client application 122, computer interface 124, database 126, authentication program 132, and database 134 are stored in persistent storage 608 for execution and/or access by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 610, in these examples, provides for communications with other data processing systems or devices, including resources of network 110. In these examples, communications unit 610 includes one or more network interface cards. Communications unit 610 may provide communications through the use of either or both physical and wireless communications links. Client application 122, computer interface 124, database 126, authentication program 132, and database 134 may be downloaded to persistent storage 608 through communications unit 610.

I/O interface(s) 612 allows for input and output of data with other devices that may be connected to computing device 120 and SAN 130. For example, I/O interface 612 may provide a connection to external devices 618 such as a keyboard, keypad, a touch screen, and/or some other suitable input device. External devices 618 can also include portable computer-readable storage media such as, for example, thumb drives, portable optical or magnetic disks, and memory cards. Software and data used to practice embodiments of the present invention, e.g., client application 122, computer interface 124, database 126, authentication program 132, and database 134, can be stored on such portable computer-readable storage media and can be loaded onto persistent storage 608 via I/O interface(s) 612. I/O interface(s) 612 also connect to a display 620.

Display 620 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as, for example, “Smalltalk” and the like may be subject to trademark rights in various jurisdictions throughout the world and are used here only in reference to the products or services properly denominated by the marks to the extent that such trademark rights may exist.

What is claimed is:

1. A computer-implemented method, the method comprising:
receiving, by one or more processors, one or more policy decisions from a primary user;
monitoring, by one or more processors, activity associated with one or more applications by a secondary user on a computing device;
detecting, by one or more processors, unauthorized activity by the secondary user on the computing device; and
in response to detecting unauthorized activity by the secondary user on the computing device, activating, by one or more processors, protected mode on the computing device.

2. The computer-implemented method of claim 1, the method further comprising:
receiving, by the one or more processors, the one or more policy decisions from the primary user;
analyzing, by the one or more processors, the one or more policy decisions from the primary user; and
storing, by the one or more processors, (i) the one or more policy decisions and (ii) the one or more identified data requests on a database.

3. The computer-implemented method of claim 1, the method further comprising:
receiving, by the one or more processors, one or more data request from the primary user;
analyzing, by the one or more processors, the one or more data requests from the primary user; and
determining, by the one or more processors, that the one or more data requests match the one or more policy decisions stored on a database.

4. The computer-implemented method of claim 3, the method further comprising:
in response to determining that the one or more data requests match the one or more policy decisions stored on the database, identifying, by the one or more processors, a threshold level of security based on (i) the one or more data requests and (ii) the one or more policy decisions;
determining, by the one or more processors, to activate protected mode on a computing device; and
generating, by the one or more processors, one or more policy responses associated with the one or more data requests that match the one or more policy decisions stored on the database, and includes, but is not limited to, a command to activate protected mode associated with threshold level of security.

5. The computer-implemented method of claim 4, the method further comprising:
communicating, by the one or more processors, the one or more policy responses;
activating, by the one or more processors, protected mode on the computing device associated with a threshold level of security;
monitoring, by the one or more processors, user activity on the computing device;
identifying, by the one or more processors, unauthorized user activity on the computing device; and
executing, by the one or more processors, a lock screen function on the computing device in response to identifying the unauthorized user activity.

6. The computer-implemented method of claim 5, the method further comprising:
populating, by the one or more processors, the computing device with a login prompt;
receiving, by the one or more processors, one or more login attempts;
analyzing, by the one or more processors, the one or more login attempts;
authorizing, by the one or more processors, a user associated with a correct login attempt; and
deactivating, by the one or more processors, the protected mode in response to authorizing a user associated with a correct login attempt.

7. The computer-implemented method of claim 6, the method further comprising:
generating, by the one or more processors, a protection report that includes, but is not limited to, (i) the one or more login attempts to authorize a user and (ii) a time and date in which a user was authorized.

8. A computer program, the computer program product comprising:
one or more computer-readable storage media and program instructions stored on the one or more computer-readable storage media, the program instructions comprising:
program instructions to receive one or more policy decisions from a primary user;
program instructions to monitor activity associated with one or more applications by a secondary user on a computing device;
program instructions to detect unauthorized activity by the secondary user on the computing device; and
in response to detecting unauthorized activity by the secondary user on the computing device, program instructions to activate protected mode on the computing device.

9. The computer program product of claim 8, the program instructions further comprising:
program instructions to receive the one or more policy decisions from the primary user;
program instructions to analyze the one or more policy decisions from the primary user; and
program instructions to store (i) the one or more policy decisions and (ii) the one or more identified data requests on a database.

10. The computer program product of claim 8, the program instructions further comprising:
program instructions receive one or more data request from the primary user;
program instructions to analyze the one or more data requests from the primary user; and
program instructions to determine that the one or more data requests match the one or more policy decisions stored on a database.

11. The computer program product of claim 10, the program instructions further comprising:
in response to determining that the one or more data requests match the one or more policy decisions stored on the database, program instructions to identify a threshold level of security based on (i) the one or more data requests and (ii) the one or more policy decisions;
program instructions to determine to activate protected mode on a computing device; and
program instructions to generate one or more policy responses associated with the one or more data requests that match the one or more policy decisions stored on the database, and includes, but is not limited to, a command to activate protected mode associated with threshold level of security.

12. The computer program product of claim 11, the program instructions further comprising:
program instructions to communicate the one or more policy responses;
program instructions to activate protected mode on the computing device associated with a threshold level of security;
program instructions to monitor user activity on the computing device;
program instructions to identify unauthorized user activity on the computing device; and
program instructions to execute a lock screen function on the computing device in response to identifying the unauthorized user activity.

13. The computer program product of claim 12, the program instructions further comprising:
program instructions to populate the computing device with a login prompt;
program instructions to receive one or more login attempts;
program instructions to analyze the one or more login attempts;
program instructions to authorize a user associated with a correct login attempt; and
program instructions to deactivate the protected mode in response to authorizing a user associated with a correct login attempt.

14. The computer program product of claim 13, the program instructions further comprising:
program instructions to generate a protection report that includes, but is not limited to, (i) the one or more login attempts to authorize a user and (ii) a time and date in which a user was authorized.

15. A computer system, the computer system comprising:
one or more computer processors;
one or more computer readable storage medium; and
program instructions stored on the computer readable storage medium for execution by at least on of the one or more processors, the program instructions comprising:
program instructions to receive one or more policy decisions from a primary user;
program instructions to monitor activity associated with one or more applications by a secondary user on a computing device;
program instructions to detect unauthorized activity by the secondary user on the computing device; and
in response to detecting unauthorized activity by the secondary user on the computing device, program instructions to activate protected mode on the computing device.

16. The computer system of claim 15, the program instructions further comprising:
program instructions receive one or more data request from the primary user;
program instructions to analyze the one or more data requests from the primary user; and
program instructions to determine that the one or more data requests match the one or more policy decisions stored on a database.

17. The computer system of claim 16, the program instructions further comprising:
in response to determining that the one or more data requests match the one or more policy decisions stored on the database, program instructions to identify a threshold level of security based on (i) the one or more data requests and (ii) the one or more policy decisions;
program instructions to determine to activate protected mode on a computing device; and
program instructions to generate one or more policy responses associated with the one or more data requests that match the one or more policy decisions stored on the database, and includes, but is not limited to, a command to activate protected mode associated with threshold level of security.

18. The computer system of claim 17, the program instructions further comprising:
program instructions to communicate the one or more policy responses;
program instructions to activate protected mode on the computing device associated with a threshold level of security;
program instructions to monitor user activity on the computing device;
program instructions to identify unauthorized user activity on the computing device; and
program instructions to execute a lock screen function on the computing device in response to identifying the unauthorized user activity.

19. The computer system of claim 18, the program instructions further comprising:
program instructions to populate the computing device with a login prompt;
program instructions to receive one or more login attempts;
program instructions to analyze the one or more login attempts;
program instructions to authorize a user associated with a correct login attempt; and
program instructions to deactivate the protected mode in response to authorizing a user associated with a correct login attempt.

20. The computer system of claim 19, the program instructions further comprising:
program instructions to generate a protection report that includes, but is not limited to, (i) the one or more login attempts to authorize a user and (ii) a time and date in which a user was authorized.
